(19) United States
(12) Patent Application Publication
(10) Pub. No.: US 2006/0171327 A1
(43) Pub. Date: Aug. 3, 2006

(54) Interference source recognition for wireless LANs

(75) Inventors: Roger Durand, Amherst, NH (US); Michael Yuen, Waltham, MA (US)

Correspondence Address: McGUINNESS & MANARAS LLP, 125 NAGOG PARK, ACTON, MA, 01720, US

(73) Assignee: Autocell Laboratories, Inc.

(21) Appl. No.: 11/103,410

(22) Filed: Apr. 11, 2005

Related U.S. Application Data
(60) Provisional application No. 60/649,799, filed on Feb. 3, 2005.

(51) Int. Cl. H04L 1/00

(52) U.S. Cl. 370/252

(57) ABSTRACT

In a wireless network having an access point and/or at least one wireless end device, the access point and/or end device is operable to differentiate between normal communications and interference from another device in order to capture a sample of the interference, determine whether the interference originates from a known type of device, and prompt remedial actions based on whether the interference originates from a known type of device. One technique for differentiating between interference and normal communications is to induce a quiet interval during which normal communications are ceased. Another technique is to employ a parallel demodulation engine. The quiet interval may be assembled from temporally non-contiguous quiet gaps between normal communications. For interference sources which exhibit a pulse waveform the interference sources are analyzed based on pulse period and duration.

### CROSS-REFERENCE TO RELATED APPLICATIONS

A claim of priority is made to U.S. Provisional Patent Application Ser. No. 60/649,799, entitled Interference Counter Measures for Wireless LANs, filed Feb. 3, 2005, which is incorporated herein by reference.

### FIELD OF THE INVENTION

This invention is generally related to wireless communications, and more particularly to coping with interference in a wireless communications network.

### BACKGROUND OF THE INVENTION

Certain wireless LAN (“WLAN”) products, such as products based on the IEEE 802.11 standard, operate in unregulated spectrum. One problem associated with operating in unregulated spectrum is the potential of encountering interference from other devices. Regulated spectrum is relatively free of interference because unlicensed products which operate in the regulated spectrum can be removed from the marketplace. Even in unregulated spectrum there is at least a possibility of negotiating strategies for coping with interference from standards-compliant devices via standards organizations. However, some of the potential interfering devices are not standards-compliant, and some are not even communications devices. There is therefore a need for techniques and devices for coping with interference in unregulated spectrum.

### SUMMARY OF THE INVENTION

In a wireless network, a technique for coping with interference from another device that adversely effects communications includes: differentiating between the interference and normal communications; determining whether the interference originates from a known type of device; and selecting a remedial action based at least in-part on whether the interference originates from a known type of device.

One technique for differentiating between interference and normal communications is to induce a quiet interval during which normal communications are ceased. Another technique is to employ a parallel demodulation engine. The parallel demodulation engine offers the advantage of obtaining interference signal data without reducing bandwidth in order to implement a quiet interval. However, the parallel demodulation engine may be less effective in comparison with use of a quiet interval when the interference signal is similar to normal communications signals. The quiet interval may be assembled from temporally non-contiguous quiet gaps between normal communications. The assembled quiet interval offers the advantage of avoiding relatively long interruptions in normal communications, and may interleave with predefined gaps in standard communications protocols. For interference sources which exhibit a pulse waveform the interference sources are analyzed based on pulse period and duration. This format offers the advantage of being relatively compact.

The invention offers improved WLAN performance when interference is encountered. By recognizing a particular source of interference it may be possible to continue communications on the channel by implementing counter measures calculated to overcome the identified interference source. Maintaining communications may be less disruptive than breaking a communications link and re-authenticating on a different channel.

### BRIEF DESCRIPTION OF THE FIGURES

FIG. 1 is a block diagram of a wireless access point and end station adapted for coping with interference.

FIG. 2 is a flow diagram illustrating a technique for coping with interference.

FIG. 3 illustrates the quiet interval in greater detail.

FIG. 4 illustrates an alternative quiet interval.

FIG. 5 is a flow diagram of the parallel processes of calculating interference signal duration and period.

### DETAILED DESCRIPTION

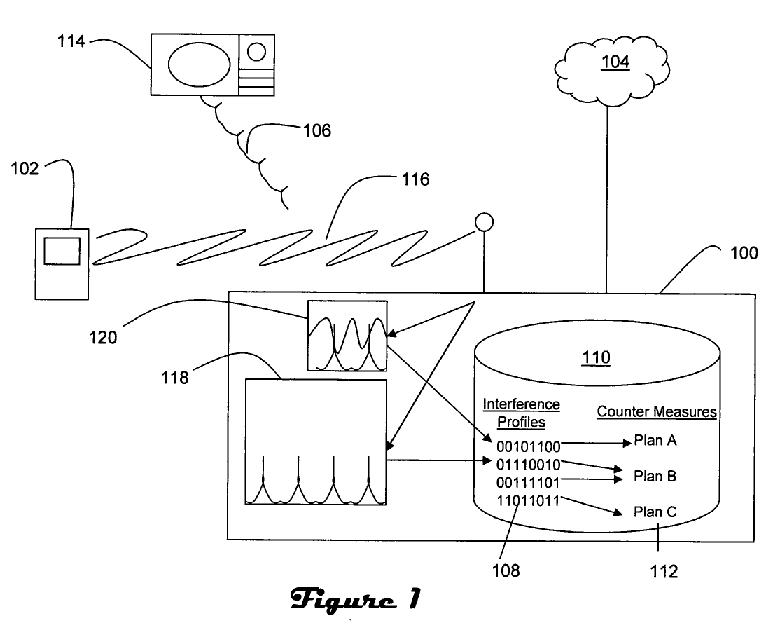

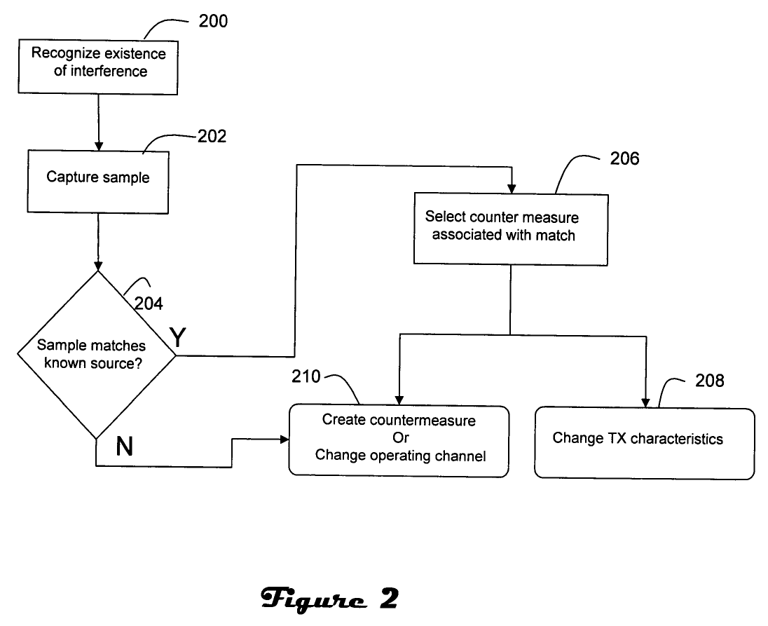

Referring to FIGS. 1 and 2, a wireless access point (100) is operative to provide network access to a wireless end station (102) such as a personal computer, PDA, notebook computer or phone. The end station (102) is typically a mobile device without wireline connections, whereas the access point (100) is typically a stationary device having a wireline connection with another network device such as switch, router or server in a network (104). Communications between the access point (100) and the end station (102) are typically two-way, and may utilize one or more channels within a predefined spectrum.

The access point (100) is adapted to recognize and respond to interference (106) generated by a device (114) other than the end station (102). For example, the access point includes a table (108) of interference profiles in memory (110) which are indicative of particular sources of interference. The memory (110) also includes a table (112) of counter measure plans which specify actions to be taken when a particular source of interference is recognized. Each counter measure plan specifies at least one remedial action, such as altering transmission characteristics and changing to an alternate communication channel. The remedial actions may be arranged hierarchically such that multiple actions are attempted in a predefined order until a satisfactory result is obtained. Each interference profile in the table (108) is associated with at least one counter measure plan in the corresponding table (112), and multiple interference profiles may be associated with a particular counter measure plan.

The first step (200) in the technique employed by the access point (100) to cope with interference is recognizing the existence of the interference (106). The access point may recognize the interference by analyzing the signal received at the access point. For example, a quiet interval may be implemented such that the signal received at the access point does not include normal traffic (116) between the access point and end station, but rather comprises any existing interference, e.g., signal (106). An alternative to use of the quiet interval is to analyze the combination of normal traffic signal (116) and interference signal (106). For example, a parallel demodulation engine (120) may be programmed to identify, from the combined signal, types of interference that differ recognizably from actual data in the channel. Alternatively, recognition of a combined signal which has a relatively high proportion of noise or is not in a format specified by the communications protocol being utilized may be used as an indication of the presence of interference. Alternatively, some communications protocols specify use of periodic communications between an access point and end station primarily to verify that the communications link is operational. Such a protocol may also be used to recognize the existence of interference when the communications link fails for purposes of the present technique.

Once the access point or wireless end station recognizes the existence of interference it then captures a sample (118) of the interference as indicated in step (202) in order to attempt to identify the source of the interference. The sample may be captured by storing a portion of the interference signal (106) received at the access point or wireless end station. The received signal, which is analog, may then be sampled and converted to digital format for processing. Each sample measurement is associated with a time stamp indicating the relative time at which the sample was obtained. Hence, the resulting data comprises sets of energy magnitude measurements and time stamps.

Because there are different possible sources of interference, and the characteristics of the interference associated those sources may vary, the sampling rate and period are selected to capture a sufficient sample to identify all known potential sources of interference stored in the digital patterns in memory. The sample (118) is then compared with the interference profiles in table (108) to identify a match, or the absence of a match, as indicated by step (204). Alternatively, an adaptive algorithm may be employed to adjust the sampling period and rate until a match between the sample and an interference profile is located or eliminated as a possibility. If a matching interference profile is located in table (108) then the associated counter measures plan is selected as indicated by step (206). As discussed above, the counter measures plan may include one or both of changing transmission signal characteristics as indicated by step (208) and changing to an alternate operating channel as indicated by step (210). If no matching interference profile is located then the access point changes to the alternate operating channel as indicated by step (210).

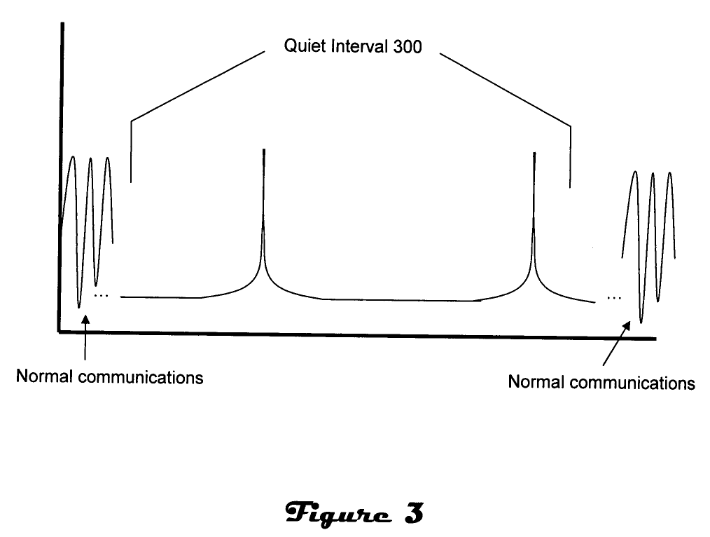

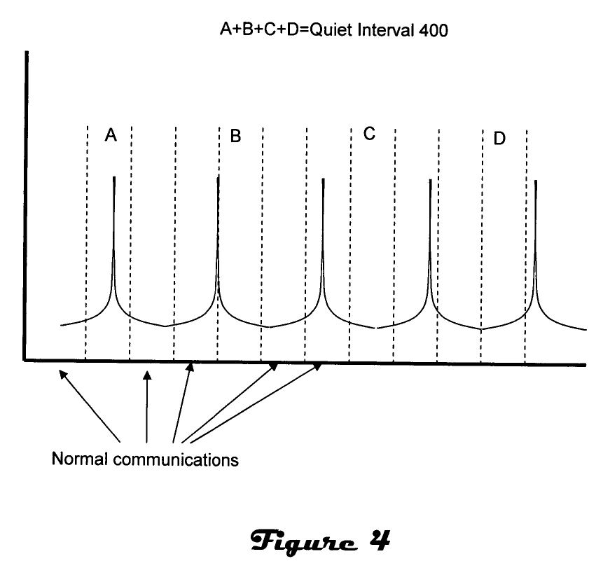

Referring FIGS. 1, 3 and 4, the quiet interval may be implemented by various techniques. For example, a quiet interval (300) may be implemented by temporarily ceasing communications until a sample of sufficient duration is obtained. Alternatively, temporally non-contiguous quiet gaps between communications may be combined via a relatively long sampling window during which the probability of having a continuously occupied channel over the entire time period is near zero to assemble a quiet interval (400).

The duration of the quiet interval and the sampling rate within the quiet interval are selected to enable identification of interference that matches any of the stored interference source profiles in table (108). In the case of an interference signal exhibiting a pulse waveform the sampling rate may be selected such that there is a minimum of 2 samples within the shortest expected pulse duration. The shortest expected interference pulse duration for some Bluetooth devices for a 2.4 GHz WLAN band is 300 microseconds, which corresponds to a maximum sample period of 150 microseconds. In other words, both the sampling period and the sampling duration would be 150 microseconds maximum. The accuracy of the time stamps also effects the sampling period requirement. For example, if the time stamps have an accuracy of +/−40 microseconds then the sampling period should be selected to be no greater than 110 microseconds so as to provide the sample period at 150 microseconds maximum. In terms of a specific example, a microwave oven might emit a >2.5 millisecond pulse which repeats every 16 milliseconds, i.e., has a 16 millisecond period. In this example searching only for pulses longer then 2.5 milliseconds by creating 2.6 millisecond quiet periods has a relatively small probability of intercepting the interference, but creating a 17 millisecond quiet interval has a 100% probability of intercepting a 2.5 millisecond pulse.

Techniques may be employed to mitigate loss of bandwidth due to implementation of the quiet interval. In particular, the quiet interval may be dynamically adjusted or interrupted based on network conditions. For example, recurring scheduled long duration measurements may be interrupted when network bandwidth utilization is high due to valid traffic requirements. Similarly, measurements may be adjusted or interrupted when the access point has a high load value, or when memory depth is filling and depleting rapidly, or when transmit and retries errors are high or low.

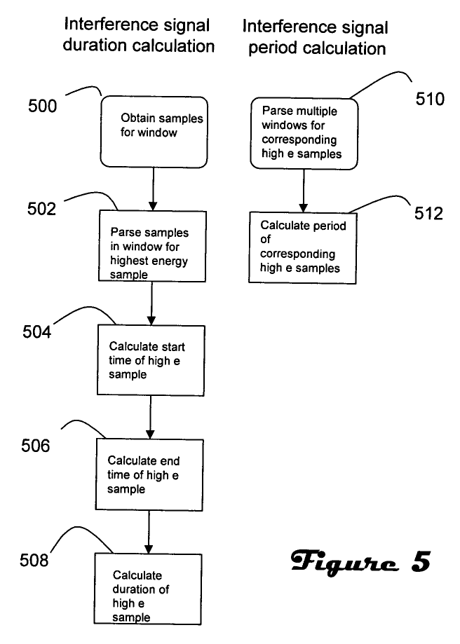

Referring to FIGS. 1 and 5, the data in table (108) and samples (118) may be expressed in various forms. For example, a relatively high resolution expression could include data sufficient to represent a near continuous waveform. Alternatively, only data points representing changes in power greater than a predetermine threshold are saved. In the illustrated embodiment, where interference sources exhibit a pulse waveform, only pulse period and duration are employed, where pulse period is indicative of the time between consecutive pulses, and pulse duration is indicative of the time during which an individual pulse exhibits a power level above a predetermined threshold, i.e., sampling noise floor. In particular, after gathering multiple data points as indicated in step (500) across a sample window as described above, parallel processes are executed to calculate interference signal duration and period. In step (502) the point of maximum energy in the sample window is identified. Once the point of maximum energy is identified, an energy level “time width” on either side of the maximum (“peak”) energy point is identified in step (508) by finding the first samples on both sides that drop to the measurement noise floor on each side of the peak as indicated by steps (504) and (506), respectively. Contemporaneously with the interference duration calculation an interference signal period calculation is executed by identifying corresponding peaks as indicated by step (510), and then calculating the time between consecutive peaks as indicated by step (512).

The technique described above for representing pulse interference sources will now be described with respect to a specific example. Given a microwave oven at 2 meters distance, with peak energy in the channel at −24 dBm, a peak energy point P1 occurs at a time T1 (time=0 Sec). The energy attributable to the microwave drops below a noise floor of −81 dBm between successive energy peaks. Having collected data for a predefined window, the energy values are compared in order to identify the highest value, P1, T1. The samples preceding P1, T1 are then parsed until a sample at P0, T0 (time=−3.7 mSec) with energy value below the noise floor is located. The samples following P1, T1 are also parsed until a sample P2, T2 (time=3 mSec) with energy value below the noise floor is located. The pulse duration is determined by calculating the time between T0 and T2, which is 6.7 mSec. The accuracy of the technique may be modified by interpolation or dithering. For example, because the samples at T0 and T2 may not have the exact energy values as the noise floor, as interpolation between sample on either side of the noise floor can be employed to enhance accuracy. The pulse period is determined by calculating the time between consecutive energy peaks, i.e., T1₂-T1₁. Consecutive peaks may be identified by searching the collected samples for samples having higher energy values than the samples immediately preceding and following. Spurious samples and secondary interference sources may be filtered by using only consecutive peaks within a predetermined range. For example, if a first detected peak has energy value xdBm then only other peaks having energy value X +/−10 dBm are considered to be related peaks. Alternatively, or in addition to the energy level comparison, more than two consecutive peaks may be compared to determine that the pulse period is constant. Any peaks which fall outside the pulse period constant by greater than a predetermined value are discarded. Again, interpolation and dithering techniques may be employed to increase accuracy.

In view of the techniques for filtering peaks described above, it will be apparent that multiple, different sources of interference that occur simultaneously on the channel can be detected and identified. In other words, the inventive technique can differentiate between the interference sources by filtering peaks, and hence generate from the received signal representative pulse period and pulse duration data sets describing each individual interference source.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative structures, one skilled in the art will recognize that the system may be embodied using a variety of specific structures. Accordingly, the invention should not be viewed as limited except by the scope and spirit of the appended claims.

What is claimed is:

1. In a wireless network having a first device and a second device, a method for coping with interference from a third device that adversely effects communications between the first device and the second device comprising the steps of:
differentiating between the interference and normal communications;
determining whether the interference originates from a known type of device; and
selecting a remedial action based at least in-part on whether the interference originates from a known type of device.

2. The method of claim 1 including the further step of selecting a remedial action based on the interference if the interference is determined to originate from an unknown type of device.

3. The method of claim 1 wherein the differentiating step includes the further step of employing first and second parallel demodulation engines, the first engine being employed for normal communications, and the second engine being employed for analyzing interference.

4. The method of claim 1 wherein the differentiating step includes the further step of inducing a quiet interval during which normal communications cease.

5. The method of claim 4 including the further step of implementing the quiet interval as a temporally continuous window.

6. The method of claim 4 including the further step of assembling the quiet interval from temporally non-contiguous segments.

7. The method of claim 4 wherein the length of the quiet interval is at least as great as the greatest expected interference signal period.

8. The method of claim 1 including the further step of sampling at a rate selected such that there is a minimum of two samples within the shortest expected interference signal duration

9. The method of claim 4 including the further step of dynamically altering quiet interval length based at least in-part on network conditions.

10. The method of claim 4 including the further step of interrupting quiet interval implementation based at least in-part on network conditions.

11. The method of claim 1 wherein the interference exhibits a pulse waveform, and including the further step of employing pulse period and pulse duration to categorize the interference.

12. The method of claim 11 including the further step of identifying multiple interference signals.

13. In a wireless network having a first device and a second device, apparatus for coping with interference from a third device that adversely effects communications between the first device and the second device comprising:
processing logic operable to differentiate between the interference and normal communications;
comparison logic operable to determine whether the interference originates from a known type of device; and
selection logic operable to select a remedial action based at least in-part on whether the interference originates from a known type of device.

14. The apparatus of claim 13 wherein the processing logic includes an auxiliary demodulation engine dedicated to analyzing interference.

15. The apparatus of claim 13 wherein the processing logic is further operable to induce a quiet interval during which normal communications cease.

16. The apparatus of claim 15 wherein the processing logic is further operable to implement the quiet interval as a temporally continuous window.

17. The apparatus of claim 15 wherein the processing logic is further operable to assemble the quiet interval from temporally non-contiguous segments.

18. The apparatus of claim 15 wherein the length of the quiet interval is at least as great as the greatest expected interference signal period.

19. The apparatus of claim 13 wherein the processing logic is further operable to sample at a rate selected such that there is a minimum of two samples within the shortest expected interference signal duration

20. The apparatus of claim 15 wherein the processing logic is further operable to dynamically alter quiet interval length based at least in-part on network conditions.

21. The apparatus of claim 15 wherein the processing logic is further operable to interrupt quiet interval implementation based at least in-part on network conditions.

22. The apparatus of claim 13 wherein the interference exhibits a pulse waveform, and wherein the comparison logic is further operable to employ pulse period and pulse duration to categorize the interference.

23. A wireless device for use in a wireless local area network comprising:
a memory having stored therein:
program code operative to differentiate between the interference and normal communications, the differentiating program code further including code operative to induce a quiet interval during which normal communications cease, and code operative to sample interference during the quiet period, and code operative to generate pulse period and pulse duration data to categorize the interference;
program code for determining whether the interference originates from a known type of device by comparing the pulse period and pulse width of the interference with stored interference profiles expressed in pulse period and pulse width; and
program code for selecting a remedial action based at least in-part on whether the interference originates from a known type of device.

24. The device of claim 23 further including program code operable to create a remedial action based at least in-part on interference measured during the quiet period.
